(19) United States
(12) Patent Application Publication
(10) Pub. No.: US 2008/0027750 A1
(43) Pub. Date: Jan. 31, 2008

(54) System and method for digital rights management

(76) Inventors: Jason E. Barkeloo, Cincinnati, OH (US); David A. Krauth, Manchester, NH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/881,820

(22) Filed: Jul. 27, 2007

Related U.S. Application Data
(60) Provisional application No. 60/833,579, filed on Jul. 27, 2006.

(51) Int. Cl. G06Q 10/00; G06F 17/40

(52) U.S. Cl. 705/1

(57) ABSTRACT

It is one aspect of the present invention to provide a method of digital content delivery including the steps of: (a) providing a client device for displaying digital content and a server device for storing digital content; (b) transmitting a first signal from the client device to the server device; (c) verifying by the server device that the client device is authorized to access the digital content; (d) upon verification, generating a temporary file by the server device, the temporary file being temporarily mapped to a location of the digital content; (e) transmitting a second signal from the server device to the client device, the second signal including information associated with a location of the temporary file; (f) linking by the client device to the location of the temporary file; and (g) transmitting the digital content from the server device to the client device.

### CROSS-REFERENCE TO RELATED APPLICATIONS

This application claims the benefit of U.S. Provisional Application Ser. No. 60/833,579, entitled “SYSTEM AND METHOD FOR USING TOUCH USER INTERFACE AS A DIGITAL RIGHTS MANAGEMENT SYSTEM,” filed on Jul. 27, 2006, the disclosure of which is incorporated herein by reference.

### FIELD OF THE INVENTION

The present invention relates to a system and method of digital content delivery. Specifically, the present invention involves secured retrieval of digital content from a digital content provider to an interactive user device.

### BACKGROUND OF THE INVENTION

Innovations have begun to transform conventional books and other printed publications into multi-media interactive devices. Printed publications have been fitted to connect electronically with computers and other media storage devices to retrieve and display digital content. In some instances, the printed publications have an integrated remote control device capable of interacting wirelessly with the media storage devices and in other instances, the printed publications are tethered to the media storage devices with a local connection such as a USB connection or cable connection. This technology enables, for example, a reader to press the pictures and words on the regular printed ink and paper page and retrieve digital content from a computer or other media storage device.

Digital content providers create and/or store digital content associated with these printed publications. Typically, this digital content is stored on a non-local server. This digital content must be secured so that unauthorized users may not access it. At the same time, the digital content must be available for authorized users for immediate access. Therefore, it would be preferable to provide an authorized user immediate access to digital content while restricting unauthorized users from accessing it. Accordingly, the present invention is designed to overcome shortcomings in the current market.

### SUMMARY OF THE INVENTION

The present invention solves the above problems by providing a digital rights management system for allowing access to digital content only to authorized users without extensive user interruption.

It is a first aspect of the present invention to provide a method of digital content delivery including the steps of: (a) providing a client device for outputting digital content and a server device for storing digital content; (b) transmitting a first signal from the client device to the server device, the first signal including a request to access the digital content; (c) verifying by the server device that the client device is authorized to access the digital content; (d) upon verification, generating a temporary file by the server device, the temporary file being temporarily mapped to a location of the digital content; (e) transmitting a second signal from the server device to the client device, the second signal including information associated with a location of the temporary file; (f) linking by the client device to the location of the temporary file; and (g) transmitting the digital content from the server device to the client device. In one embodiment of the first aspect, the method also includes the step of: (h) outputting a representation of the digital content on the client device.

In one embodiment of the first aspect, the step of transmitting a first signal from the client device to the server device includes transmitting content identification information and the step of verifying by the server device that the client device is authorized to access the digital content includes comparing the content identification information from the client device to a content identification information database stored on the server device. In another embodiment of the first aspect, the content identification information is mapped to the location of the temporary file. In another embodiment of the first aspect the step of transmitting a second signal from the server device to the client device includes transmitting to the client device a Uniform Resource Locator address of the temporary file.

In another embodiment of the first aspect, the method also includes the step of: upon generating a temporary file by the server device, adding a record to a management database, the record including information associated with at least one of location of the temporary link, time of generation of the temporary file and a time-to-live value of the temporary file. In another embodiment of the first aspect, the method also includes the step of determining by the server device if the time-to-live value of the temporary file is exceeded. In another embodiment of the first aspect, the method also includes the step of upon determination that the time-to-live value of the temporary file has been exceeded, deleting by the server device the temporary file.

It is a second aspect of the present invention to provide a digital content delivery system including an interactive user device adapted to request digital content, a user computer device adapted to generate and transmit one or more request signal, the one or more request signal corresponding to the request from the interactive user device, the user computer device further adapted to receive the digital content, the user computer device having a display mechanism adapted to display the digital content and a content server device adapted to generate and transmit one or more response signal to the user computer device, the content server device including a storage database adapted to store the digital content and a temporary file linked to the digital content. In this aspect, the one or more response signal from the content server device is transmitted to the user computer device, the one or more response signal being associated with a location of the temporary file.

In one embodiment of the second aspect, the content server device further includes an authentication database adapted to authenticate a user computer device and the one or more request signal from the user computer device is compared to records in the authentication database to determine if the user computer device is authorized to access the digital content. In another embodiment of the second aspect, the one or more response signal includes a Uniform Resource Locator address of the temporary file.

In another embodiment of the second aspect, the content server device further includes a management database having records associated with at least one of location of the temporary link, time of generation of the temporary file and a time-to-live value of the temporary file. In yet another embodiment of the second aspect, the temporary file is deleted by the content server device upon expiration of the time-to-live value of the temporary file. In yet another embodiment of the second aspect, the one or more request signal includes at least one of an ISBN identifier, a user name, a subscriber identifier, or a unique password.

It is a third aspect of the present invention to provide a digital content delivery system that includes an interactive printed publication including printed objects associated with digital content, the printed objects having location coordinates relative to the interactive printed publication, an interactive user device having circuitry adapted to generate and transmit one or more location signal associated with the location coordinates, a media output device adapted to receive one or more content signal and output digital content, and a content server device adapted to generate and transmit the one or more content signal to the media output device, the content server device including a database adapted to store the digital content and a temporary file linked to a location of the digital content. The one or more content signal from the content server device is transmitted to the media output device, the one or more content signal being associated with a location of the temporary file.

In one embodiment of the third aspect, the media output device generates the one or more location signal based, at least in part, on the location coordinates of the printed object. In another embodiment of the third aspect, the one or more content signal includes a Uniform Resource Locator address of the temporary file. In another embodiment of the third aspect, the one or more location signal includes at least one of an ISBN identifier, a user name, a subscriber identifier and a password. In yet another embodiment of the third aspect, the content server device is further adapted to authenticate the one or more location signal based, at least in part, on at least one of an ISBN identifier, a user name, a subscriber identifier and a password.

From the foregoing disclosure and the following detailed description of various preferred embodiments it will be apparent to those skilled in the art that the present invention provides a significant advance in the art of digital rights management systems and methods. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawings in which:

FIG. 1 depicts a diagram of an exemplary embodiment of the digital rights management architecture.

### DETAILED DESCRIPTION

It will be apparent to those skilled in the art that many uses and variations are possible for the system and method disclosed herein. The following detailed discussion of various alternative and preferred embodiments will illustrate the general principles of the invention. Other embodiments will be apparent to those skilled in the art given the benefit of this disclosure.

Recently, printed publications have been fitted to connect electronically with computers 20 and other media output devices 20 (such as display devices or audio devices) to retrieve and display digital content (such printed publications shall be referred to as “interactive hybrid printed material” 22 or “IHPM” 22). In some instances, the IHPMs 22 have an integrated remote control device capable of interacting wirelessly with the media output devices 20 (herein, a “remote interactive hybrid printed material” 22 or “remote IHPM” 22), and in other instances, the IHPMs 22 are tethered to the media output devices 20 with a local connection such as a USB connection or cable connection. This technology enables, for example, a reader to press the pictures and words on the regular printed ink and paper page and retrieve digital content from a computer 20 or other media output device 20. Examples of such IHPMs 22 are described in U.S. Pat. Nos. 5,624,265, 5,757,304, 5,749,735, 5,763,112, 5,788,507, 5,839,905, 5,911,582, 5,957,695, 6,327,459 and 6,650,867, the disclosures of which are incorporated by reference.

In accordance with one embodiment of the present invention, a digital rights management system and method is disclosed to provide secure and flexible delivery for the proprietary digital data delivered by a digital content provider. In one embodiment, the digital rights management architecture is based on a client/server model, where the client is the locally- or remotely-connected interactive hybrid printed material 22 and the server is a remote storage device 23 maintained by the digital content provider. This system follows a round-trip path, initiated by the user of the interactive hybrid printed material 22, of the data delivery request and response mechanism.

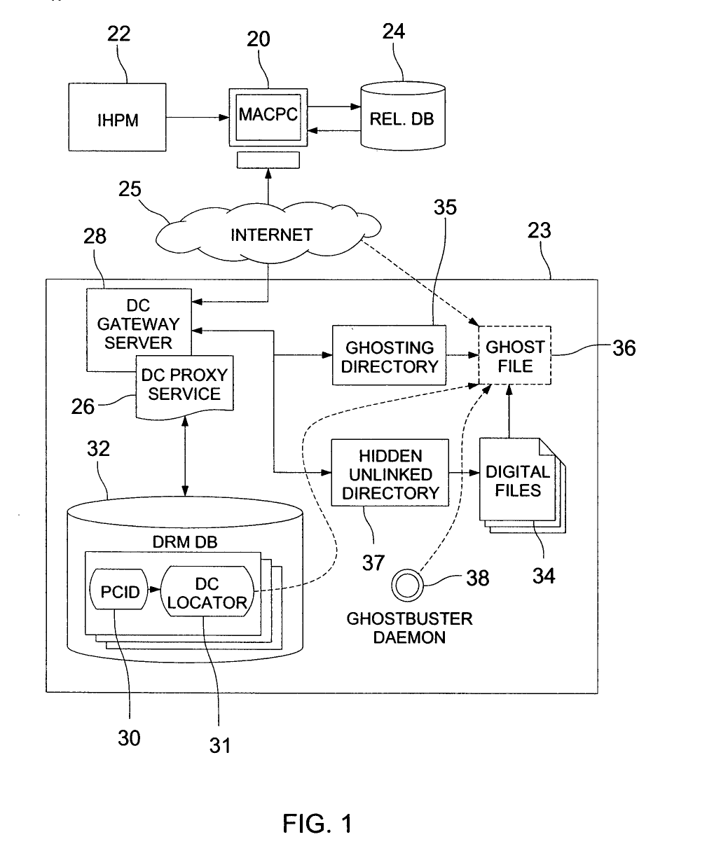

Referring to FIG. 1, the remote interactive hybrid printed material 22 generally includes a remote control circuitry, a printed publication having printed content, and a membrane switch connected to the remote control circuitry. The remote control circuitry is capable of transmitting a wireless signal to a media output device 20 wherein an application running on the media output device 20 displays the desired results. The membrane switch of the IHPM 22 has a visual association with text and/or graphic content on the remote control. The function and/or data indicated by the text and/or graphic content visually associated with the pressed membrane switch is used by the media output device 20 in outputting associated electronic content. The associated electronic content is encoded and/or stored in one or more remote storage device 23. The IHPM 22 allows a user to simply press the membrane switch (e.g., push button or touch sensitivity pad) on the interactive hybrid printed material 22 to cause the media output device 20 to access electronic content from the remote storage device 23. The membrane switch may be any type of device capable of sensing and responding to pressure—for example, a push button, koala pad, or touch sensitivity pad.

As noted earlier, an exemplary embodiment of the present invention may integrate the interactive hybrid printed material 22 and the media output device 20. In such an embodiment, the IHPM 22 and the media output device 20 of the present embodiment may be combined into a single device. In this embodiment, the IHPM 22 may include the printed publication having printed content and the membrane switch. The IHPM 22 will also be wired to circuitry that transmits the touch location and other information over local or networked connections. By combining the IHPM 22 and the media output device 20, the system may require less hardware, thus reducing the system cost.

In an exemplary embodiment, when the user touches the text and/or graphics on the interactive hybrid printed material 22, pressure from the touch operates the underlying membrane switch (e.g., push button or touch sensitivity pad). In response to the activation of the membrane switch, the circuitry of the interactive hybrid printed material 22 generates and transmits a signal to the media output device 20 and by way of a client application running on the media output device 20 to a reference database 24. As used herein, the term “media output device” 20 is intended to mean any electronic device such as a computer, television, personal digital assistant, or cell phone that is able to output (visually and/or audibly) associated digital content. The signal from the interactive hybrid printed material 22 carries data (e.g., x and y coordinates) indicative of the touched location and/or the touched item on the interactive hybrid printed material 22. The client application retrieves the appropriate response from the reference database 24, which has been formatted with a URL and a provider content identifier. The URL is the static address of a digital content proxy service 26 on a network 25 (such as the Internet) to which the media output device 20 is coupled by any known network connection. The application sends a request to the digital content proxy service 26 containing a provider content identifier, as well as the subscriber credentials, which can be a concatenation of any or all of the following: ISBN, user name, subscriber identifier or other unique password.

The digital content proxy service 26 operates on a digital content gateway server 28 and can function as one of many types of standard Internet services (HTTP) such as CGI or ASP. Upon receiving the provider content identifier and subscriber credentials, the digital content proxy service 26 authenticates the request by comparing the provider content identifier to provider content identifiers 30 in a digital rights management database 32. The digital content proxy service 26 uses the provider content identifier to locate the desired digital content 34 and generates a temporary file 36, known as a ghost file 36, linking to the secure, hidden content 34. The digital content proxy service 26 places an entry into the digital rights management database 32 that contains a random file name path associated with the location of the ghost file 36. This random file name path describes a specific directory 35 or address (or ghosting directory 35 as shown in FIG. 1) within the remote storage device 23 where the ghost file 36 is located. This random file name path helps keep the specific directory 35 or location of the ghost file 36 hidden from unauthenticated access. In turn, the directory 37 or address of the digital content 34 remains hidden. The database entry is mapped to the provider content identifier value received from the media output device 20. This mapping essentially correlates the provider content identifier value with the specific directory 35 or address of the ghost file 36. The digital content proxy service 26 then returns a data packet containing the URL of the ghost file 36 to the media output device 20. At this point, the media output device 20 will load the URL of the ghost file 36 into a browser operating thereon. The browser is then directed to the URL of the digital content 34 linked from the ghost file 36.

In one exemplary embodiment, a digital content locator 31 uses the provider content identifier to locate the desired digital content 34. The digital content locator 31 then generates a temporary file 36, known as a ghost file 36, linking to the secure, hidden digital content 34.

In another exemplary embodiment, the digital content proxy service 26 also generates an entry in the digital rights management database 32 that contains a timestamp of the creation and/or a time-to-live (TTL) value. The actual ghost file 36 filename would then be created as a symbolic link (a placeholder or pointer to the actual digital content file 34) in a separate directory accessible via a network 25.

In another exemplary embodiment, a special routine 38 (also known as a ghostbuster daemon 38 in FIG. 1) is periodically run on the remote storage device 23 that will check the digital rights management database 32 for ghost files 36 that have met or exceeded their TTL values. Matching entries would be removed and the ghost file 36 deleted. The special routine 38 may include the execution of instructions by the remote storage device 23. The special routine 38 may also include any other form of software application operating continuously or otherwise.

It should be understood that the remote storage device 23 on which at least part of the exemplary system is operating (and which may appear in the appended claims) may be a single computer server device, a networked group of computer servers, or any other networked computer device or computerized device or system of computer devices or computerized devices on which the tools and/or processes of the exemplary embodiments may operate. This may also include any device capable of storing digital content or digital information.

The apparatuses, uses, and methods disclosed herein have been described without reference to specific hardware. However, the apparatuses, uses, and methods disclosed herein have been described in a manner sufficient to enable persons of ordinary skill in the art to readily adapt commercially available hardware as may be needed to reduce any of the embodiments of the present invention to practice without undue experimentation.

Following from the above description and invention summaries, it should be apparent to persons of ordinary skill in the art that, while the methods and apparatuses herein described constitute exemplary embodiments of the present invention, it is to be understood that the inventions contained herein are not limited to the above precise embodiments and that changes may be made without departing from the scope of the invention as defined by the claims. Likewise, it is to be understood that the invention is defined by the claims and it is not necessary to meet any or all of the identified advantages or objects of the invention disclosed herein in order to fall within the scope of the claims, since inherent and/or unforeseen advantages of the present invention may exist even though they may not have been explicitly discussed herein.

What is claimed is:

1. A method of digital content delivery, comprising the steps of:
providing a client device for outputting digital content and a server device for storing digital content;
transmitting a first signal from the client device to the server device, the first signal including a request to access the digital content;
verifying by the server device that the client device is authorized to access the digital content;
upon verification, generating a temporary file by the server device, the temporary file being temporarily mapped to a location of the digital content;
transmitting a second signal from the server device to the client device, the second signal including information associated with a location of the temporary file;
linking by the client device to the location of the temporary file; and
transmitting the digital content from the server device to the client device.

2. The method of digital content delivery of claim 1, further comprising the step of:
outputting a representation of the digital content on the client device.

3. The method of digital content delivery of claim 1, wherein the step of transmitting a first signal from the client device to the server device includes transmitting content identification information; and
the step of verifying by the server device that the client device is authorized to access the digital content includes comparing the content identification information from the client device to a content identification information database stored on the server device.

4. The method of digital content delivery of claim 3, wherein the content identification information is mapped to the location of the temporary file.

5. The method of digital content delivery of claim 1, wherein the step of transmitting a second signal from the server device to the client device includes transmitting to the client device a Uniform Resource Locator address of the temporary file.

6. The method of digital content delivery of claim 1, further comprising the step of:
upon generating a temporary file by the server device, adding a record to a management database, the record including information associated with at least one of location of the temporary link, time of generation of the temporary file and a time-to-live value of the temporary file.

7. The method of digital content delivery of claim 6, further comprising the step of:
determining by the server device if the time-to-live value of the temporary file is exceeded.

8. The method of digital content delivery of claim 7, further comprising the step of:
upon determination that the time-to-live value of the temporary file has been exceeded, deleting by the server device the temporary file.

9. A digital content delivery system, comprising:
an interactive user device adapted to request digital content;
a user computer device adapted to generate and transmit one or more request signal, the one or more request signal corresponding to the request from the interactive user device, the user computer device further adapted to receive the digital content, the user computer device having a display mechanism adapted to display the digital content; and
a content server device adapted to generate and transmit one or more response signal to the user computer device, the content server device including a storage database adapted to store the digital content and a temporary file linked to the digital content;
wherein the one or more response signal from the content server device is transmitted to the user computer device, the one or more response signal being associated with a location of the temporary file.

10. The digital content delivery system of claim 9, wherein the content server device further includes an authentication database adapted to authenticate a user computer device; and
wherein the one or more request signal from the user computer device is compared to records in the authentication database to determine if the user computer device is authorized to access the digital content.

11. The digital content delivery system of claim 9, wherein the one or more response signal includes a Uniform Resource Locator address of the temporary file.

12. The digital content delivery system of claim 9, wherein the content server device further includes a management database having records associated with at least one of location of the temporary link, time of generation of the temporary file and a time-to-live value of the temporary file.

13. The digital content delivery system of claim 12, wherein the temporary file is deleted by the content server device upon expiration of the time-to-live value of the temporary file.

14. The digital content delivery system of claim 9, wherein the one or more request signal includes at least one of an ISBN identifier, a user name, a subscriber identifier and a password.

15. A digital content delivery system, comprising:
an interactive printed publication including printed objects associated with digital content, the printed objects having location coordinates relative to the interactive printed publication;
an interactive user device having circuitry adapted to generate and transmit one or more location signal associated with the location coordinates;
a media output device adapted to receive one or more content signal and output digital content;
a content server device adapted to generate and transmit the one or more content signal to the media output device, the content server device including a database adapted to store the digital content and a temporary file linked to a location of the digital content;
wherein the one or more content signal from the content server device is transmitted to the media output device, the one or more content signal being associated with a location of the temporary file.

16. The digital content delivery system of claim 15, wherein the interactive user device generates the one or more location signal based, at least in part, on the location coordinates of the printed object.

17. The digital content delivery system of claim 15, wherein the one or more content signal includes a Uniform Resource Locator address of the temporary file.

18. The digital content delivery system of claim 15, wherein the one or more location signal includes at least one of an ISBN identifier, a user name, a subscriber identifier and a password.

19. The digital content delivery system of claim 15, wherein the content server device is further adapted to authenticate the one or more location signal based, at least in part, on at least one of an ISBN identifier, a user name, a subscriber identifier and a password.
